(19) United States
(12) Patent Application Publication
(10) Pub. No.: US 2014/0269389 A1
(43) Pub. Date: Sep. 18, 2014

(54) System and Method for Determining an Angle of Arrival in a Wireless Network

(71) Applicant: Microchip Technology Incorporated, Chandler, AZ (US)

(72) Inventors: Andras Gyorgy Bukkfejes, Budapest (HU); Peter Szilveszter Kovacs, San Jose, CA (US)

(21) Appl. No.: 14/208,031

(22) Filed: Mar. 13, 2014

Related U.S. Application Data
(60) Provisional application No. 61/784,046, filed on Mar. 14, 2013.

(51) Int. Cl. H04W 24/08

(52) U.S. Cl. CPC H04W 24/08
USPC 370/252

(57) ABSTRACT

Angle of arrival (AoA) in a radio frequency (RF) network having radio devices at unknown positions is determined by using a specially built RF locator device. Any kind of modulation comprising, for example but not limited to, Direct Sequence Spread Spectrum (DSSS) symbols can be decoded by the RF locator device using complex correlation. The RF locator device is connected to an antenna array with multiple antenna elements that are switched between DSSS symbols. The RF locator device determines correlation magnitude and angle data of the radio device for further processing. Collecting DSSS symbols with CFO compensated correlation magnitude and phase results from different locations enables electrical beam forming for determining the AoA by sweeping this beam around an angle of view of the antenna array. This AoA determination may be performed on multiple channels and packets to reduce the effects of multi-path propagation.

### RELATED PATENT APPLICATION

This application claims priority to commonly owned U.S. Provisional Patent Application Ser. No. 61/784,046; filed Mar. 14, 2013; which is hereby incorporated by reference herein for all purposes.

### TECHNICAL FIELD

The present disclosure relates to a wireless network setup configured to determine an angle of arrival of IEEE 802.15.4 radio frequency (RF) packets and locate their source.

### BACKGROUND

Wireless networks, in particular wireless networks according to the IEEE 802 standard, such as for example the IEEE 802.15, and in particular IEEE 802.15.4, which provides for a wireless network in a 50 meter communication range with a transmission rate of 250 kbit/s. There exist various implementations that build on the basic IEEE 802.15.4 standard, such as ZigBee, MiWi, and the like. Some of which use proprietary wireless protocols and may enhance the transmission rate. Transmitters in wireless networks, e.g., such as IEEE 802.15.4 networks, often operate in a radio wave reflection rich environment, and determining the position(s) (location(s)) of such transmitter(s) is desired.

### SUMMARY

Therefore a need exists for a wireless network setup that is capable of determining the position(s) (location(s)) of its transmitting and/or receiving node(s).

According to an embodiment, a method for determining an angle of arrival in a wireless network may comprise the steps of: receiving a plurality of packets with a plurality of antennas of an antenna array, wherein each one of the plurality of antennas may sequentially receive symbols of the plurality of packets transmitted from a transmitter; measuring and compensating carrier frequency offset (CFO) on a selected portion of each of the received plurality of packets; determining a phase difference between each received symbol and a reconstructed phase of a signal from the transmitter; and determining an angle of arrival (AoA) of the signal using directional characteristics of the antenna array.

According to a further embodiment of the method, the plurality of packets may be transmitted on a plurality of different frequencies to reduce multipath propagation affecting determination of the AoA. According to a further embodiment of the method, may comprise the step of providing angle data of each received packet to a microcontroller. According to a further embodiment of the method, the microcontroller may switch between different ones of the plurality of antennas after receiving an interrupt. According to a further embodiment of the method, a receiver may be coupled to the antenna array switches between different ones of the plurality of antennas. According to a further embodiment of the method, the step of determining signal angle data may be performed with a quasi-coherent receiver that calculates a complex correlation for each received packet. According to a further embodiment of the method, the step of calculating the complex correlation for each received packet may comprise a correlation magnitude and angle for each one of the plurality of packets received. According to a further embodiment of the method, an interrupt to the microcontroller may be delayed to compensate for processing latency and antenna switching time. According to a further embodiment of the method, the receiver coupled to the antenna array may delay switching between the different ones of the plurality of antennas to compensate for processing latency and antenna switching time.

According to a further embodiment of the method, the plurality of packets may comprise a plurality of direct sequence spread spectrum (DSSS) symbols. According to a further embodiment of the method, the DSSS symbols may be IEEE standard 802.15.4 compliant. According to a further embodiment of the method, the plurality of packets may be transmitted using offset quadrature phase-shift keying (OQPSK) modulation of the signal.

According to another embodiment, a method for determining an angle of arrival in a wireless network may comprise the steps of: transmitting a plurality of packets with a plurality of antennas of an antenna array, wherein each one of the plurality of antennas may sequentially transmit symbols of the plurality of packets to a receiver; measuring and compensating carrier frequency offset (CFO) on a selected portion of each of the plurality of packets received by the receiver; determining a phase difference between each received symbol and a reconstructed phase of a signal from the transmitter; and determining an angle of arrival (AoA) of the signal using directional characteristics of the antenna array.

According to a further embodiment of the method, the plurality of packets may be received on a plurality of different frequencies to reduce multipath propagation affecting determination of the AoA. According to a further embodiment of the method, the step of providing angle data of each received packet may be provided to a microcontroller associated with the antenna array. According to a further embodiment of the method, the microcontroller may switch between different ones of the plurality of antennas after receiving an interrupt. According to a further embodiment of the method, a transmitter coupled to the antenna array may switch between different ones of the plurality of antennas. According to a further embodiment of the method, the step of determining signal angle data may be performed with a quasi-coherent receiver that calculates a complex correlation for each received packet. According to a further embodiment of the method, the step of calculating the complex correlation for each received packet may comprise a correlation magnitude and angle for each one of the plurality of packets received. According to a further embodiment of the method, an interrupt to the microcontroller may be delayed to compensate for processing latency and antenna switching time. According to a further embodiment of the method, the transmitter coupled to the antenna array may delay switching between the different ones of the plurality of antennas to compensate for processing latency and antenna switching time. According to a further embodiment of the method, the plurality of packets may comprise a plurality of direct sequence spread spectrum (DSSS) symbols. According to a further embodiment of the method, the DSSS symbols may be IEEE standard 802.15.4 compliant.

According to yet another embodiment, a method for determining an angle of arrival in a wireless network may comprise the steps of: collecting angle data on every symbol boundary of a packet after an interrupt request; pushing the angle data to a buffer when a packet may be received without a cyclic redundancy check (CRC) error; selecting a first packet from the buffer; estimating residual carrier frequency offset (CFO) in first symbols of the packet using only one of a plurality of antennas; estimating and compensating CFO for a subsequent plurality of symbols received on the plurality of antennas; grouping samples of the received subsequent plurality of symbols with respective ones of the plurality of antennas; estimating angle of arrival (AoA) on a given packet using an integer and enhanced version of Fourier estimation; appending correlation versus angle results to an averaging sum; collecting estimation results from multiple packets on multiple channels having largest possible frequency differences for spectral averaging; and reporting results of the spectral averaging. According to a further embodiment of the method, the spectral averaging report may be provided to a user interface.

According to still another embodiment, a method for determining an angle of arrival in a wireless network may comprise the steps of: providing an antenna array having a plurality of antenna elements; providing a semi-coherent receiver for receiving and demodulating a plurality of packets received on at least one of the plurality of antenna elements; switching between the plurality of antenna elements for receiving a plurality of packets to determine residual carrier frequency offsets (CFO) for each one of the plurality of packets, and to switch between the plurality of antenna elements for determining correlation phase values at different locations; measuring a residual CFO on a portion of every packet; compensating the residual CFO for a remaining part of every packet; and determining signal angle data for each one of the received packets based upon which ones of the plurality of antennas received the respective ones of the plurality of packets.

According to a further embodiment of the method, an integer and enhanced version of Fourier estimation may determine the AoA of the plurality of packets received. According to a further embodiment of the method, may comprise the steps of: receiving multiple packets on multiple channels with multiple ones of the plurality of antenna elements to compensate for multi-path propagation; and accumulating the multiple packets in a sum to perform spectral averaging thereof.

According to another embodiment, a system for determining an angle of arrival in a wireless network may comprise: a transmitter for transmitting a plurality of packets; an antenna array may comprise a plurality of antennas; an antenna switch coupled to the plurality of antennas; a receiver coupled to the antenna switch, wherein the antenna switch couples the receiver to each of the plurality of antennas, one at a time; a digital device coupled to the receiver and the antenna switch; the receiver receives the plurality of packets with the plurality of antennas, wherein each one of the plurality of antennas sequentially receives symbols of each packet transmitted from the transmitter; the receiver measures and compensates for carrier frequency offset (CFO) on a selected portion of each of the received plurality of packets; the receiver determines a phase difference between each received symbol and a reconstructed phase of a signal from the transmitter; and the digital device determines an angle of arrival (AoA) of the signal using directional characteristics of the antenna array.

According to a further embodiment, the digital device may be a microcontroller. According to a further embodiment, the antenna array may comprise a plurality of patch antennas. According to a further embodiment, the antenna array may comprise four patch antennas. According to a further embodiment, the plurality of patch antennas may be fabricated on an insulated substrate and an air gap core. According to a further embodiment, the plurality of patch antennas may be circularly polarized. According to a further embodiment, each of the plurality of patch antennas may be spaced apart greater than one-half wavelength. According to a further embodiment, isolation switches may be provided between the plurality of antennas and the antenna switch. According to a further embodiment, the receiver may be a quasi-coherent receiver that calculates a complex correlation for each received packet. According to a further embodiment, the directional characteristics of the antenna array are adjusted by switching each of the plurality of antennas.

According to yet another embodiment, a system for determining an angle of arrival in a wireless network may comprise: a receiver for receiving a plurality of packets; a digital device coupled to the receiver; an antenna array comprising a plurality of antennas; an antenna switch coupled to the plurality of antennas; a transmitter coupled to the antenna switch, wherein the antenna switch couples the transmitter to each of the plurality of antennas, one at a time; the transmitter transmits the plurality of packets with the plurality of antennas, wherein each one of the plurality of antennas transmits packets comprising symbols; the receiver measures and compensates for carrier frequency offset (CFO) on a selected portion of each of the received plurality of packets; the receiver determines a phase difference between each received symbol and a reconstructed phase of a signal from the transmitter; and the digital device determines an angle of arrival (AoA) of the signal using directional characteristics of the antenna array.

According to a further embodiment, the digital device may be a microcontroller. According to a further embodiment, the receiver may be a quasi-coherent receiver that calculates a complex correlation for each received packet. According to a further embodiment, the directional characteristics of the antenna array may be adjusted by switching each of the plurality of antennas.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic block diagram of a system for determining an angle of arrival of a signal in a wireless network, according to a specific example embodiment of this disclosure;

FIG. 2 illustrates a partial schematic block diagram of a system for determining an angle of arrival of a signal in a wireless network where a locator sequentially transmits packets on separate antennas and a single antenna receiver determines an angle of arrival thereof, according to another specific example embodiment of this disclosure;

FIG. 3 illustrates a schematic block diagram of a receiver architecture, according to specific embodiments of this disclosure;

FIG. 4 illustrates a four element patch antenna array, according to specific example embodiments of this disclosure;

FIG. 5 illustrates a schematic graph shown in a Descartes coordinate plane of a Fourier estimation using four (4) patch antenna elements, according to specific example embodiments of this disclosure;

FIG. 6 illustrates a schematic graph shown in a Polar coordinate plane of a Fourier estimation using four (4) patch antenna elements, according to specific example embodiments of this disclosure;

FIG. 7 illustrates a schematic graph shown in a Descartes coordinate plane of a Fourier estimation using two (2) patch antenna elements, according to specific example embodiments of this disclosure;

FIG. 8 illustrates a schematic graph shown in a Polar coordinate plane of a Fourier estimation using two (2) patch antenna elements, according to specific example embodiments of this disclosure;

FIG. 9 illustrates a schematic graph shown in a Descartes coordinate plane of a Fourier estimation for detection of the largest received power within a 20 degree angle, according to specific example embodiments of this disclosure;

FIG. 10 illustrates a schematic graph shown in a Polar coordinate plane of a Fourier estimation for detection of the largest received power within a 20 degree angle, according to specific example embodiments of this disclosure;

FIG. 11 illustrates a schematic graph shown in a Descartes coordinate plane of a Fourier estimation of an antenna array having only one path within a 20 degree angle and with element distances of 100 mm, according to specific example embodiments of this disclosure;

FIG. 12 illustrates a schematic graph shown in a Polar coordinate plane of a Fourier estimation of an antenna array having only one path within a 20 degree angle and with element distances of 100 mm, according to specific example embodiments of this disclosure;

FIG. 13 illustrates a schematic diagram of an antenna array that is excited with a plane electromagnetic wave, according to the teachings of this disclosure; and

FIG. 14 illustrates a schematic program map of an operation for determining an angle of arrival of a signal in a wireless network, according to a specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

### General System Description

Referring to FIG. 1, depicted is a schematic block diagram of a system for determining an angle of arrival of a signal in a wireless network, according to a specific example embodiment of this disclosure. A radio frequency (RF) TAG 100 transmits RF packets from an unknown location. An antenna array 102 may comprise a plurality of antennas, e.g., circularly polarized patch antennas, that receive these RF packets transmitted from the RF tag 100. Each antenna 102a, 102b, 102c and 102d (four shown for exemplary purposes only) is switched with an isolation switch 104a, 104b, 104c and 104d, respectively, that may be proximate to an antenna 102 coupled thereto. These isolation switches 104 preferable are proximate (close) to their respective antennas 102 so as to decrease the crosstalk among transmission lines (50 Ohm microstrip lines in this embodiment) by switching the currently unused antennas off them. The transmission lines 106 preferably are substantially the same length so as not to introduce phase shift errors on the RF signals propagating therethrough. The transmission lines 106 are coupled to a multi-input port antenna switch 108 that has a common port coupled to a RF port of a RF transceiver 110.

The RF transceiver 110 receives, detects and decodes the RF packets sent by the RF TAG 100. Decoded information from the RF transceiver 110, e.g., status information from the TAG—battery voltage, operation mode, additional sensors data like gyro, accelerometer, compass to enhance localization results or any kind of user data is sent to a digital device 118, e.g., microcontroller unit (MCU), for further processing as described more fully hereinafter. Packet payload does not matter.

The RF transceiver 110 and/or RF TAG 100 may be, for example but is not limited to, a MRF24XA RF transceiver (a product of Microchip Incorporated www.microchip.com). The MRF24XA datasheet is available at www.microchip.com, and is incorporated by reference herein for all purposes. It is contemplated and within the scope of this disclosure that any other kind of radio device with similar features described herein may be used to provide angle data from any IEEE 802.15.4 standard or proprietary packets, according to the teachings of this disclosure, and one having ordinary skill in the art of digital communications and having the benefit of this disclosure could easy design same using any one or more of such RF transceivers.

The digital device 118 may control the antenna switch 108 and/or the isolation switches 104 over control lines 114 and 116, respectively. It is contemplated and within the scope of this disclosure that the RF transceiver 110 may control the antenna switch 108 and/or the isolation switches 104 instead of the digital device 118 (control lines between the RF transceiver 110 and the switches 104 and 108 (not shown but may be implied). Transmission of the information from the RF transceiver 110 to the digital device 118 may be over a digital serial bus 112, e.g., an SPI interface, an interrupt line for real time antenna switching, and, possibly one or more lines for general radio interrupts. Processed information output from the digital processor 118 may be provided via an interface bus 122, e.g., personal computer (PC) interface bus, e.g., USB, Firewire, Ethernet, RS-232, or even Wireless if it is not using the same frequency as the RF transceiver 110 doing the location of the RF tag 100.

The architecture of this specific example embodiment depends on the hardware support provided for localization in the RF transceiver 110, e.g., Microchip MRF24XA RF transceiver. The RF transceiver 110 is capable of storing correlation magnitude and phase data, however, any such RF transceiver that is capable of measuring magnitude and angle data for incoming RF signals may be used and is contemplated herein. Using such a hardware device in combination with the system and method disclosed herein may provide for electrical beam forming and angle of arrival (AoA) estimation. For electrical beam forming, magnitude and phase data are needed from multiple transmitting locations.

In the embodiment shown in FIG. 1 Receive mode localization may be implemented. This means that any type of IEEE 802.15.4 compliant RF TAGs 100 may transmit a signal, e.g., packets. The RF transceiver 110 with a properly designed antenna array 102, according to the teachings of this disclosure, may receive the TAG signal, e.g., packets, and perform beam forming thereafter. To achieve this, multiple antennas 102 may be placed at proper locations and RF switches 104 and/or 108 may be used to connect the RF transceiver 110 to the desired antennas 102 in time sequence. Using only one RF switch 108 might not provide sufficient isolation between the transmission lines 106, thereby affecting the RF isolation between the antennas 102. Therefore, the addition of RF isolator switches 104 in each of the transmission lines 106 may provide for better signal isolation between the antennas 102 then using only the antenna switch 108 by itself.

Referring to FIG. 2, depicted is a partial schematic block diagram of a system for determining an angle of arrival of a signal in a wireless network where a locator (as shown in FIG. 1) sequentially transmits packets on separate antennas and a single antenna receiver determines an angle of arrival thereof, according to another specific example embodiment of this disclosure. An RF transceiver 210 in a RF TAG 200 uses the same RX localization feature described in this disclosure, but with a single antenna 202. The RF transceiver 110 on the locator with multiple antennas 102 has hardware support for a transmit localization mode. This is substantially the same operation as shown in FIG. 1, but the other way around where the RF transceiver 110 transmits and the antennas 102 radiate the phase shifted by space diversity packets (FIG. 1) to the receiving RF TAG 200. In this case the RF transceiver 110 (FIG. 1) transmits each direct-sequence spread spectrum (DSSS) symbol on a different antenna 102 after the carrier frequency offset (CFO) determination period. Antenna switching during DSSS symbol transmit mode may be implemented in the same way as shown for the receive mode localization described herein. The RF transceiver 210 of the RF TAG 200 may receive the packets on a single antenna 202 and provide magnitude and phase data for the MCU 218 of the TAG 200 in the same way as described herein for each packet. Since the AoA dependent phase shift is included in the transmitter AoA (from the RF transceiver 110 and antennas 102 shown in FIG. 1), it may be calculated in the same way. The RF transceiver 200 may be, for example but is not limited to, a MRF24XA RF transceiver or any other kind of radio device with similar features as described herein.

By using the RF TAG 200 in a Receive mode, a plurality of RF TAGs 200 may simultaneously receive the transmitted packets from the locator (RF transceiver 110 and antennas 102) to determine a respective angle of arrive of the packets received at each RF TAG 200. This may provide location and/or movement indications rapidly for a large number of RF TAGs 200 from only a single set of packet transmissions using the RF transceiver 110 and the plurality of antennas 102. For example, “smart” shopping charts, each having a RF TAG 200; high value merchandise; e.g., televisions, cell phones, personal computers, jewelry, and the like. Each RF TAG 200 may also send its respective angle of arrival after calculation to a central monitoring station (not shown) that could display each RF TAG 200 location, change in location, and/or rate of change from one location to another. These features may effectively be used to monitor the TAG 200 locations for inventory and/or security purposes.

Antenna Design

Based on beam forming theory, an antenna array must have magnitude and phase data from different locations, e.g., spatial differentiation. The following steps may provide for building an appropriate antenna array for indoor localization of an RF tag:

Selecting a basic antenna type for the elements of an antenna array,

determining antenna element count, and

determining distance(s) between the antenna elements.

Selecting Antenna Type

According to the beam forming theory any type of antenna array may be used and have +/−90 degree angle of view with the array. In real life situations if the antennas are close to each other (e.g., d<λ) then significant interference will be observed between them that could corrupt the angle measurement. This is why it is preferable to choose antenna types that can provide sufficient (>˜20 dB) isolation between the elements. In the 2.4 GHz range, for example, patch antennas will fulfill the above mentioned requirement. Polarization also has an important role. In the case of cross polarization damping on the direct path, a user will observe around 20 dB signal loss. In the case where there may exist a reflection that may cause polarization change, then the reflected signal may be larger than the one from the direct path. Thus, circularly polarized patch antennas may be the optimal choice.

Localization requires no extra antenna design. It should run as normal depending on the user's need. A user might desire low cost production, thus patch antennas can be made on a glass epoxy FR4 (or FR4+air gap) substrate. Alternative substrates may be used such as, for example but are not limited to, ceramic materials that may result in a smaller size antenna array assembly. For the example antenna array shown in FIG. 4, an FR4 substrate plus air gap core may comprise square truncated, circularly polarized patch antennas.

Antenna Element Count

The number of patch antennas used may determine the width of the electrically formed beam. The more elements there are the narrower will be the beam. Thus angle resolution may be determined by the element count. Note also that the beam width depends on the type of beam forming method used for the antenna array. To achieve approximately one (1) degree precision, four (4) antenna elements were chosen. The beam in this configuration and using the Fourier estimation is sharp enough to distinguish directions in approximately one (1) degree precision. This precision may be dependent upon the environment. So a typical environment is assumed for the approximate one (1) degree precision.

Referring to FIG. 5, depicted is a schematic graph shown in a Descartes coordinate plane of a Fourier estimation using four (4) patch antenna elements, according to specific example embodiments of this disclosure. Referring to FIG. 6, depicted is a schematic graph shown in a Polar coordinate plane of a Fourier estimation using four (4) patch antenna elements, according to specific example embodiments of this disclosure. The beam is approximately +/−16 degrees wide, and sharp enough to distinguish within approximately one (1) degree.

Referring to FIG. 7, depicted is a schematic graph shown in a Descartes coordinate plane of a Fourier estimation using two (2) patch antenna elements, according to specific example embodiments of this disclosure. Referring to FIG. 8, depicted is a schematic graph shown in a Polar coordinate plane of a Fourier estimation using two (2) patch antenna elements, according to specific example embodiments of this disclosure. The beam is approximately +/−40 degrees. The beam width here is much wider and not sharp enough to distinguish within one (1) degree precision. FIGS. 5-8 are simulated in +/−90 degrees angle of view. The more important problem with a wide beam is that multiple paths cannot be distinguished! In the antenna embodiment shown in FIG. 4, four (4) patch elements were selected for this reason. Other applications may need more or less number of antenna elements, depending on the environment and the resolution required.

Comparing FIGS. 6 and 8, using only the polar (4 element and 2 element, respectively), for the case of four (4) elements the total beam width is 32 degrees, which is a much sharper beam compared to the two (2) element case where the beam width is 80 degrees and flat. Finding maximum points and the corresponding angle in a real environment is more precise with a narrow beam. According to measurements in typical environments, four (4) antennas may be needed for one (1) degree precision. A sharp beam is preferable to distinguish between the direct path and the result of a reflection. (In case of reflection multiple peaks are present; usually the larger is the direct path). If the beam is too sharp than it may find too many reflections +/−5 degrees around the direct path that may make further processing harder.

Determining Distance Between Antenna Elements

According to beam forming theory, antenna element shall be placed within a distance of less than λ/2. With the current dielectric core (FR4+air gap) the patch element width is approximately 48 millimeters, while λ/2 in air is approximately 62.5 mm. Therefore the distance between the edges of the neighboring patch antennas would be approximately 14.5 mm. If the patch antennas are placed this close, then sufficient isolation cannot be achieved. However, if the patch antennas are placed farther apart, e.g., greater than λ/2, then the effect of aliasing comes in. This means an extra beam appears more or less perpendicular to the normal one. The exact angle and the size of this beam depend upon the distance of the antenna arrays. When this beam gets electrically rotated, then the aliased beam may rotate into the angle of view, resulting in false alarms.

An example of this aliasing effect, when a virtual transmitter is placed far enough from the antennas (30 meters in this simulation). Using d=50 millimeters (mm) and d=100 mm antenna distances. Referring to FIGS. 9 and 10, depicted are Fourier estimation graphs of an antenna array having only one path within a 20 degree angle and a distance of the elements is 50 mm (<λ/2). FIG. 9 shows a Descartes plot and FIG. 10 shows a polar plot for detecting the largest received power from 20 degrees. For the 50 mm distance there is only one main lobe.

Referring to FIGS. 11 and 12, depicted are Fourier estimation graphs of an antenna array having only one path within a 20 degree angle and a distance of the elements is 100 mm. FIG. 11 shows a Descartes plot and FIG. 12 shows a polar plot for detecting the largest received power within a 20 degree angle. For the 100 mm distance there are two lobes, the main lobe and an aliasing lobe. Preferably, the smallest interference possible is desired, thus the antennas may be placed as far apart as possible to be operational at +/−45 degrees (this allows a user to place the locator device shown in FIG. 1 in corners of a room and have the room fully covered). The size of the aliasing lobe is dependent upon the antenna distance. Thus a simulator was built to determine the maximum distance in aforementioned antenna design that fulfills this angle of view requirement. It turned out that approximately an 80 mm center to center distance may be optimal to fulfill the requirements for this embodiment.

Simulator Operation

The following steps may be used in determining an optimal antenna array spacing:
1) Place a virtual Tag everywhere with 1 degrees step in the desired field of view (+/−45 degrees in this embodiment) in front of an array where the distance of the elements is a parameter.
2) Estimate the TAG's position with the given array setup for all angles.
3) Check if estimation error is less than the required 1 degrees for all angles, and
4) Perform the same method with another array setup.
   For requirements having different design parameters, the aforementioned steps may be used for determining optimal distance for an optimal antenna array and field of view requirement.

Referring to FIG. 4, depicted is a four element patch antenna array, according to a specific embodiment of this disclosure. Each patch antenna may be approximately 48 mm square; the center to center distances between patch antennas may be approximately 80 mm, and FR4 fiberglass core substrate 460 of about 1.5 mm thickness plus a 5 mm air gap between the reflector plane and the printed circuit board (PCB). The patch antenna typically comprises two parts: the patch itself and a reflector plane. An RF conductive metal reflector plane may be provided on a bottom layer of a 1.5 mm thick PCB, however in that case optimal bandwidth may not be achieved. When the distance between the reflector plane and the patch is increased the bandwidth of the patch antenna will also increase. The feed point impedance for this antenna simulation may be approximately 50 ohms.

Receiver Architecture and Internal CFO Compensation

In wireless communication systems the synthesized carrier frequency is dependent upon crystal oscillator frequency stability and accuracy. The crystal oscillator frequency not being exact or absolutely stable over temperature causes both transmit and receive impairments, carrier frequency offset and sampling drift offset. The IEEE 802.15.4 standard specifies +/−40 ppm carrier frequency offset tolerance with respect to a nominal value. This represents +/−80 ppm worst case deviation between two nodes. The baseband processor in an MRF24XA RF transceiver 110 is designed to estimate and compensate for that amount of carrier frequency offset (CFO). Furthermore, the MRF24XA RF transceiver 110 has a block-coherent receiver chain for demodulating IEEE 802.15.4 compliant signals. Referring to FIG. 3, depicted is a schematic block diagram of a receiver architecture, according to specific embodiments of this disclosure. In RX mode the MRF24XA RF transceiver 110 may be represented by the schematic block diagram shown in FIG. 3.

The receiver architecture shown in FIG. 3 may contain the following function blocks.
1. An analog-to-digital converter (ADC) 418 may be used to convert the incoming I/Q signals from the RF tag 100 received signal into the digital domain. The sampling frequency may be 8 mega-samples per second (MSps). The digitized signal is denoted by x in FIG. 3.
2. A matched filter 422 may perform frequency discrimination on the incoming I/Q samples, according to the following equations:

$${y}_{i , a} = {\sum }_{n}^{M} {x}_{i - n} \cdot {e}^{- j \frac{π}{8} \cdot ( \frac{1}{2} + i ) \cdot {( - 1 )}^{a}}$$

$${z}_{i} = \vert {y}_{i , 0} \vert - \vert {y}_{i , 1} \vert$$

Where α∈[0,1]. 0 means the “+” rotation while 1 means the “−” rotation.
3. A preamble correlator 434 performs convolution between the matched filter 422 output z, and the preamble defined in the IEEE 802.15.4 standard.

$${M}_{i} = \frac{1}{L} {\sum }_{n = 0}^{L - 1} {z}_{i - 4 n} \cdot {c}_{n}$$

Where cₘ=−1 −1 1 1 −1 1 1 −1 −1 1 1 1 −1 1 −1 1 1 1 1 −1 1 1 1 −1 −1−1 −1 −1 −1 1 1 1.
Please note that the sequence may be converted to a MSK format. L is the number of chips in a DSSS symbol (=32).
4. DSSS Demodulator 424 may perform 16 concurrent de-spreading operations. Each of the de-spreader operations corresponds to one of the 32-chip long sequences defined in the IEEE 802.15.4 standard.

$${r}_{n , k} = {\sum }_{m = 0}^{L - 1} {y}_{L \cdot n + m , a} \cdot {e}^{- j {\sum }_{l = 0}^{m} {cs}_{m + 1 , k} \cdot {( - 1 )}^{l}}$$

$$a = \{ \begin{matrix}{cs}_{m + 1 , k} \cdot {cs}_{m , k} \cdot {( - 1 )}^{m} < 0 & {}^{″} {-}^{″} MFhypothesis \\ {cs}_{m + 1 , k} \cdot {cs}_{m , k} \cdot {( - 1 )}^{m} > 0 & {}^{″} {+}^{″} MFhypothesis\end{matrix} \}$$

$${dec}_{n} = {max}_{k} \vert {r}_{n , k} \vert$$

Where L is the number of chips in a DSSS symbol (=32), n is the DSSS symbol number and the cs_{m,k} variable stands for the m^{th} chip of the k^{th} DSSS sequence in O-QPSK manner.
5. A COORDIC 428 may be used to convert the complex correlation from Cartesian to Polar coordinates as is well known to a person of ordinary skill in the communications arts.
6. Automatic frequency control (AFC) 430 may be used to estimate the carrier frequency offset.

$${θ}_{n} = ( ( arg ( {r}_{n , {dec}_{n}} ) - arg ( {r}_{n - 1 , {dec}_{n - 1}} ) + π ) mod 2 π ) - π$$

$${CFO}_{n} = \frac{{θ}_{n} \cdot 2 e 12}{2 π \cdot L \cdot {f}_{carrier}} [ Hz ]$$

for a 2 MSps sampling frequency.
7. A numerically controlled oscillator 432 and digital mixer 420 may be used to compensate for the carrier frequency offset.

The receiver control flow may have the following steps during packet reception:
a) Initialization
b) Wait until the magnitude of the preamble correlation (M) exceeds a predefined threshold limit
c) Perform 2 consecutive DSSS symbol correlation for CFO estimation purpose
d) Compute the angle of the DSSS symbols calculated in the previous step
e) Calculate the CFO for the actual packet, and control the NCO+MIXER for the rest of the packet
f) SFD search and payload processing
g) At the end of the packet go to a)

After the internal CFO estimation is finished in e), the AFC operation is frozen, thus no CFO tracking is implemented on the rest of the packet. Please note, that residual CFO is always present (<13 ppm @ 2.4 Ghz), the MCU 118 can take care of that during post-processing. The baseband processor may perform the COORDIC 428 function for each and every incoming DSSS symbol and provide angle and correlation magnitude information to the MCU 118. These angle and correlation magnitude information values may be stored in a register (not shown) of the MCU 118 after the reception of every DSSS symbol. In order for the MCU 118 to timely receive this data, an interrupt may be asserted from the RF transceiver 110 to the MCU 118. At each DSSS symbol boundary, the RF transceiver 110 (e.g., MRF24XA) may set a timer based on an internal register value. The interrupt may be set when this timer expires. This adjustable delay enables the programmer to fine tune constant interrupt handling time(s) to make sure antennas are switched approximately at the boundaries and have measurement results read before the next symbol arrives.

Integer Beam Forming Theory

Referring to FIG. 13, depicted is a schematic diagram of an antenna array that is excited with a plane electromagnetic wave, according to the teachings of this disclosure. The antenna array as shown in FIG. 13 may comprise a plurality of antenna elements (N shown) and have distances between them of d. A plane wave RF signal from a RF tag 100, having an angle of arrival of θ, may be received as a complex signal on each of the antennas 102. The resulting signal, y, may be expressed as:

$$y = {\sum }_{i = 1}^{N} {z}_{i} {h}_{i} \qquad ( 1 )$$

Where N is the number of antenna elements, d is the distance between the antenna elements, θ is the angle of arrival of the plane wave, Zᵢ is the received complex signal on each antenna, hᵢ is a complex multiplier for the respective antenna element, and Σ is the complex sum of the received signal inputs to the antenna elements 102.

Looking at the geometry shown in FIG. 13, it is clear that the plane wave coming from θ direction will generate the following receive signal vector:

s^{T}(θ)=[1e^{-iφ} . . . e^{-i(N-1)φ]} (2)

### Where

$$ϕ = d * \frac{2 π}{λ} sin ( θ ) \qquad ( 3 )$$

Where all notations are above except is the wavelength in air, and s^{T} denotes “s transpose.”

To maximize y in case of plane wave excitation from θ than we have to select an h vector accordingly:

h(θ)=s*(θ) (4)

Where s* denotes “s conjugate.”
The output y may be calculated using matrix notation:

y(θ)=z^{T}h=h^{T}z=s*(θ)=s^{H}(θ)z (5)

Where s^{H} denotes “s transpose conjugate.”

If we want to get the mean received signal power:

Pₘ(θ)=Mean(|y(θ)|²)=s^{H}(θ)Mean(z*z^{H})s(θ)=s^{H}(θ)Rs(θ) (9)

Where:

R=Mean(z*z^{H}) (7)

Up to this point the aforementioned equations comprise the conventional way of electrical beam forming. Localization may be used with other estimation methods, and is contemplated herein for all purposes.

What to do when θ is not known

In case the angle of arrival is not known than we have to calculate average received signal strength for all angles in the angle of view with the desired precision, and check which estimated angle gets the highest average receive power (+/−45 degrees with 1 degree precision in the case of the specific example embodiment disclosed herein). In this case we implement the formulas just as explained above but the solution will not be optimized for calculation time.

Ways to improve computation time
Representation change—In case where the transceiver reports angle data in integer format
1) Angle representation: RF transceiver 110 represents angles in 12 bit two's complement format (−2048 represents −π and +2047 represents +π).
2) Zᵢ results may be read out in the following format:

zᵢ=corrmag*e^{i*corrang} (8)

Where: Corrmag is the correlation magnitude from the RF transceiver 110 for a given symbol and Corrang is the correlation angle from the RF transceiver 110 for the given symbol.
3) The targeted MCU device does not have floating point unit, thus integer calculation may save significant time.
4) To avoid representation change to double, the sine and cosine functions have been redefined to be functional directly with the angle representation of the radio. With those functions real and imaginary part could be calculated for Z.
5) These trigonometric functions normally return results in the −1 . . . 1 range. A constant integer multiplier has been applied so that the even the result of these trigonometric functions may be stored as an integer value.
6) With this special representation the calculated Pₘ(θ) does not have any physical meaning
7) This loss of real units does not cause any problem in getting the results, as the present method searches for the angle where Pₘ(θ) is maximum. Therefore the maximum value is not required.

Fourier estimation works only if residual CFO is compensated for as more fully described in commonly owned United States Patent Application Publication US 2012/0276921 A1; Pub. Date Nov. 1, 2012; entitled “Radio Frequency TAG Location System and Method,” by Jozsef Nemeth; and is hereby incorporated by reference herein for all purposes. The change is that the “Residual CFO Compensation” part was re-defined for the integer representation similar to this one.

Simplifications in the Matrix Operation

Formula (6) above requires a deeper analysis in order to start simplification: solution is shown for four (4) antenna elements, but works for any size antenna array. Ways to improve calculation:
1) All matrices inside the equation are complex however only the real part of the result is needed.
2) No matter of the input values the matrices have a special form that allows simplification.
   Matrix R may be special as it may have the following form:

$${zz}^{H} = [ \begin{matrix}{z}_{1} \\ {z}_{2} \\ {z}_{3} \\ {z}_{4}\end{matrix} ] [ \begin{matrix}{z}_{1}^{*} & {z}_{2}^{*} & {z}_{3}^{*} & {z}_{4}^{*}\end{matrix} ] = [ \begin{matrix}a & {e}^{*} & {h}^{*} & {j}^{*} \\ e & b & {f}^{*} & {i}^{*} \\ h & f & c & {g}^{*} \\ j & i & g & d\end{matrix} ] \qquad ( 9 )$$

Matrix is almost symmetric, as we have complex conjugate pairs on each side of the main diagonal. Replacing this form into the equation with substituting the s vectors in a similar form

$$\begin{matrix}{P}_{m} = [ \begin{matrix}{s}_{1}^{*} & {s}_{1}^{*} & {s}_{3}^{*} & {s}_{4}^{*}\end{matrix} ] [ \begin{matrix}a & {e}^{*} & {h}^{*} & {j}^{*} \\ e & b & {f}^{*} & {i}^{*} \\ h & f & c & {g}^{*} \\ j & i & g & d\end{matrix} ] [ \begin{matrix}{s}_{1} \\ {s}_{2} \\ {s}_{3} \\ {s}_{4}\end{matrix} ] \\ = \begin{matrix}{s}_{1} {s}_{1}^{*} a + & {s}_{1} {s}_{2}^{*} e + & {s}_{1} {s}_{3}^{*} h + & {s}_{1} {s}_{4}^{*} j + \\ {s}_{1}^{*} {s}_{2} {e}^{*} + & {s}_{2} {s}_{2}^{*} b + & {s}_{2} {s}_{3}^{*} f + & {s}_{2} {s}_{4}^{*} i + \\ {s}_{1}^{*} {s}_{3} {h}^{*} + & {s}_{2}^{*} {s}_{3} {f}^{*} + & {s}_{3} {s}_{3}^{*} c + & {s}_{3} {s}_{4}^{*} g + \\ {s}_{1}^{*} {s}_{4} {j}^{*} + & {s}_{2}^{*} {s}_{4} {i}^{*} + & {s}_{3}^{*} {s}_{4} {g}^{*} + & {s}_{4} {s}_{4}^{*} d\end{matrix}\end{matrix} \qquad ( 10 )$$

What we have to do is calculate the real part of the sum at the end of the equation above. With the elementary rules of complex calculation it may be shown for any complex number a=(a₁+ia₂), b=(b₁+ib₂), c=(c₁+ic₂):

ab*=(a*bc*)* (11)

This implies that

Real(ab*c)=Real(a*bc*)=a₁b₁c₁+a₂b₂c₁+a₁b₂c₂−a₂b₁c₂ (12)

With the mathematical simplifications in (11) and (12) it is clear that the final sum at the end of (10) may be calculated as follows:

1) All the values in the “diagonal” are real. They have to be calculated.

2) It is enough to calculate the real part one side of the “diagonal” and multiply it by two.

3) Further enhancement can be applied as S₁=1

In the example embodiment running on a microprocessor at 80 MIPS, integer calculations may take approximately three (3) milliseconds while non-enhanced calculations may take up to 26 milliseconds. Ambiguity may exist due to incoming interrupt timing. Similar simplifications should work with other kinds of beam forming methods and are contemplated herein for all purposes.

Angle Estimation Task

According to some embodiments of this disclosure, the MCU 118 may provide the following: Collect angle data on every symbol boundary after an interrupt request and push the angle data to a buffer in case a given packet was received without a cyclic redundancy check (CRC) error. In the main loop if the circular buffer is not empty, the first packet is selected and the following calculation may be performed: a) Normalize the angle results that were read from the quasi-coherent receiver (e.g., changing representation from 12 bit two's complement to integer). b) Estimate residual CFO in the first symbols, where only one antenna was used for reception continuously. c) Compensate CFO on the rest of the symbols, for example according to the method described in United States Patent Application Pub. No.: US 2012/0276921 A1, incorporated by reference herein for all purposes. d) Group the samples for the corresponding antennas and perform, for example but not limited to, a Fourier estimation (Electrical beam forming) for all angles in the angle of view with the required precision. The result of estimation on one packet is the correlation results in function of the tested angles. e) Append result to a sum that accumulates these results from other packets that could have been taken on other channels. Similar spectral averaging functions are performed on spectrum analyzers. f) In case the results from the given number of packets have been added to the sum, plot angle versus correlation and find the maximum correlation and the corresponding angle thereof g) Report the estimated angle or the complete estimation graph. In the plot there may be multiple peaks in case of reflections. In most of the cases (when the RF TAG 100 was placed accordingly) one of these peaks is the angle of the direct path, but it is not necessarily the highest one. This is why this sum may be used for additional multi-path canceling when redundant information is available.

Referring to FIG. 14, depicted is a schematic program map of an operation for determining an angle of arrival of a signal in a wireless network, according to a specific example embodiment of this disclosure. A RF TAG 100 transmits IEEE 802.15.4 compliant packets (or any kind of packets with direct-sequence spread spectrum (DSSS)) to a receiving RF transceiver 110. The numeral 130 represents DSSS symbol boundaries. According to IEEE standard 802.15.4 PHY, 2 Mbps chip rate is used with 16 different 32 chip long DSSS code. Thus one code represents 4 bits at 250 kbps. This is why symbol boundaries are 16 μs after each other symbol boundaries that may be found all over the packet. The numeral 134 represents the end of a RF TAG 100 transmission. The numeral 136 represents after some time the RF TAG 100 starts sending another packet, possibly on another radio frequency channel.

The RF transceiver 110 receives the packet and during the packet preamble phase performs a hardware carrier frequency offset (CFO) estimation to increase sensitivity and improve signal-to-noise ratio (SNR). Lines 138 indicate the position of the delayed symbol boundary. The exact position/delay may be adjustable through a register in the RF transceiver 110. This may be used to tune propagation and handling times so as to make sure the MCU 118 switches antennas 102 exactly at DSSS symbol boundaries. The numeral 140 represents a delayed DSSS symbol interrupt request to the MCU 118, and the numeral 142 represents a delayed DSSS symbol interrupt handler in the MCU 118.

The MCU 118 may perform the following on delayed DSSS symbol interrupt request 140:
1) Perform antenna switching if CFO period is over with (e.g., 100 ns precision on the DSSS boundaries). For example, the number of symbols needed for CFO was determined in simulation. Raw measurement data was simulated on a computer and the same calculation run. After optimization, it was determined that 40 symbols gave the best results when using a MRF24XA RF transceiver 110.
2) Receive correlation data is sent to the MCU 118 over an interface bus 122 (see FIG. 1).
3) The received correlation data is stored in a buffer of the MCU 118.
   In other RF transceivers there may be enough memory to store this data for a complete packet. Also this switching scheme may be implemented in the RF transceiver 110 hardware. Having that capability, the MCU 118 interaction need only be when a packet is received.

The numeral 144 represents an interrupt request from the RF transceiver 110 to the MCU 118 at the end of packet. Input port 146 of the MCU 118 receives the interrupt request 144 from the RF transceiver 110. In localization mode the interrupt 144 may be handled in the following way:
1) Read Interrupt registers to determine what caused the interrupt.
2) MRF24XA has multiple interrupts. For localization Packet received and Packet filtered interrupt are relevant.
3) Packet filter interrupt is raised when the packet was corrupted (CRC failed) or when destination address does not match (it means that the packet was sent to another device). When the first DSSS symbol arrives the receiver does not know anything of the packet so data will be stored. This is why when packet gets filtered the buffer content should be discarded.
4) Packet received interrupt:
   a. In the case when the source address does not match the device address that is being tracked may then be discarded.
   b. In the case when the packet is from an appropriate device then push pending measurement data to the buffer and clear packet timeout counter (packet timeout is mentioned herein among the tasks).

The numeral 148 represents buffer processing where every time there is valid measurement data in the buffer, data processing starts. Basically this is one possible time when the angle estimation task may run that consists of the steps more fully described hereinabove under the heading Angle Estimation Task.

FIG. 14 shows the main operations happening in parallel, according to the teachings of this disclosure. The left portion of FIG. 14 shows what the transmitting RF TAG 100 may do, the middle portion shows the operation of the RF transceiver 110, and the portion on the right shows MCU 118 operations. Time elapses from top to bottom of FIG. 14. The RF TAG 100 transmits packets periodically. DSSS symbol boundaries are marked by lines 130. These boundaries follow each other every 16 μs as defined in the IEEE 802.15.4 standard (in this current embodiment).

The RF transceiver 110 on the receiver end (in the RF TAG location system of this embodiment) receives these packets wirelessly. For every packet the RF transceiver 110 may perform internal CFO compensation in two steps: a) during the preamble phase, and b) during angle estimation to reduce residual CFO; as more fully described in commonly owned United States Patent Application Publication US 2012/0276921 A1; Pub. Date Nov. 1, 2012; entitled “Radio Frequency TAG Location System and Method,” by Jozsef Nemeth; and is hereby incorporated by reference herein for all purposes. During packet reception the RF transceiver 110 may generate the delayed DSSS boundary interrupt requests 140 towards the MCU 118. The delay between the physical DSSS boundary and the interrupt may be defined by an internal register in the RF transceiver 110.

At the end of every packet (shown as numeral 134) the RF transceiver 110 may perform internal filtering based on the parameters in its registers and described in more detailed in the MRF24XA datasheet is available at www.microchip.com, and is incorporated by reference herein for all purposes. Possible filters may be, for example but are not limited to, Filter CRC, destination address mismatch, packet type mismatch, and other filters more fully disclosed in the MRF24XA datasheet. In the case where the packet gets filtered, then the RF transceiver 110 may set a general interrupt request towards the MCU 118 and set flags that may indicate a filtered packet. In the case when the packet is CRC correct and was not filtered, then a receive interrupt flag may be set internally and a general interrupt may be sent in the same way. In this embodiment the DSSS interrupt line and the general radio interrupt line may be on different ports. When the MCU 118 receives these interrupts it may perform the operations described for the delayed DSSS symbol interrupt 142, input port 146 of the MCU 118 receiving the interrupt request 144 from the RF transceiver 110, and data processing 148 more fully described hereinabove.

It is contemplated and within the scope of this disclosure that the plurality of packets may be transmitted using any form or type of modulation that allows extraction of the complex correlation angle and magnitude from signals having a modulation index of at least 0.25 (e.g., minimum shift keying), and preferably for multiples of 0.25 where the modulation index may be about 0.25*n, where n may be a positive integer. For example, but not limited to, continuous phase frequency shift-keying (CPFSK) and offset quadrature phase-shift keying (OQPSK).

It is contemplated and within the scope of this disclosure that the plurality of packets may be transmitted using any form or type of modulation that allows extraction of the complex correlation angle and magnitude from frequency shift keying (FSK) signals having a modulation index of at least 0.25 (e.g., minimum shift keying), and preferably for multiples of 0.25 where the modulation index may be about 0.25*n, where n may be a positive integer. For example, but not limited to, offset quadrature phase-shift keying (OQPSK).

It is contemplated and within the scope of this disclosure that the systems and methods describe herein are functional with any kind of radio device capable of measuring the magnitude and phase of the incoming signal, and one having ordinary skill in art of digital communications design and having the benefit of this disclosure could easily come up with alternate designs that would still be within the scope and spirit of the claims herein. See also commonly owned U.S. Pat. No. 8,548,033 B2; entitled “Automatic Frequency Control Under Low Signal-to-Noise Conditions,” by Jozsef Nemeth, which is hereby incorporated by reference herein for all purposes.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method for determining an angle of arrival in a wireless network, said method comprising the steps of:
receiving a signal comprising a plurality of packets with a plurality of antennas of an antenna array, wherein each one of the plurality of antennas sequentially receives symbols of the plurality of packets transmitted from a transmitter;
measuring and compensating carrier frequency offset (CFO) of the signal from a selected portion of each of the received plurality of packets;
determining a phase difference between each received symbol and a reconstructed phase of the signal from the transmitter; and
determining an angle of arrival (AoA) of the signal using directional characteristics of the antenna array.

2. The method according to claim 1, wherein the plurality of packets are transmitted on a plurality of different frequencies to reduce multipath propagation affecting determination of the AoA.

3. The method according to claim 1, further comprising the step of providing angle data of each received packet to a microcontroller.

4. The method according to claim 3, wherein the microcontroller switches between different ones of the plurality of antennas after receiving an interrupt.

5. The method according to claim 1, wherein a receiver coupled to the antenna array switches between different ones of the plurality of antennas.

6. The method according to claim 1, wherein the step of determining signal angle data is performed with a quasi-coherent receiver that calculates a complex correlation for each received packet.

7. The method according to claim 6, wherein the step of calculating the complex correlation for each received packet comprises a correlation magnitude and angle for each one of the plurality of packets received.

8. The method according to claim 4, wherein an interrupt to the microcontroller is delayed to compensate for processing latency and antenna switching time.

9. The method according to claim 5, wherein the receiver coupled to the antenna array delays switching between the different ones of the plurality of antennas to compensate for processing latency and antenna switching time.

10. The method according to claim 1, wherein the plurality of packets comprise a plurality of direct sequence spread spectrum (DSSS) symbols.

11. The method according to claim 1, wherein the DSSS symbols are IEEE standard 802.15.4 compliant.

12. A method for determining an angle of arrival in a wireless network, said method comprising the steps of:
collecting angle data on every symbol boundary of a packet after an interrupt request;
pushing the angle data to a buffer when a packet is received without a cyclic redundancy check (CRC) error;
selecting a first packet from the buffer;
estimating residual carrier frequency offset (CFO) in first symbols of the packet using only one of a plurality of antennas;
estimating and compensating CFO for a subsequent plurality of symbols received on the plurality of antennas;
grouping samples of the received subsequent plurality of symbols with respective ones of the plurality of antennas;
estimating angle of arrival (AoA) on a given packet using an integer and enhanced version of Fourier estimation;
appending correlation versus angle results to an averaging sum;
collecting estimation results from multiple packets on multiple channels having largest possible frequency differences for spectral averaging; and
reporting results of the spectral averaging.

13. The method according to claim 12, wherein the spectral averaging report is provided to a user interface.

14. A method for determining an angle of arrival in a wireless network, said method comprising the steps of:
providing an antenna array having a plurality of antenna elements;
providing a semi-coherent receiver for receiving and demodulating a plurality of packets received on at least one of the plurality of antenna elements;
switching between the plurality of antenna elements for receiving a plurality of packets to determine residual carrier frequency offsets (CFO) for each one of the plurality of packets, and to switch between the plurality of antenna elements for determining correlation phase values at different locations;
measuring a residual CFO on a portion of every packet;
compensating the residual CFO for a remaining part of every packet; and
determining signal angle data for each one of the received packets based upon which ones of the plurality of antennas received the respective ones of the plurality of packets.

15. The method according to claim 14, wherein an integer and enhanced version of Fourier estimation determines the AoA of the plurality of packets received.

16. The method according to claim 14, further comprising the steps of:
receiving multiple packets on multiple channels with multiple ones of the plurality of antenna elements to compensate for multi-path propagation; and
accumulating the multiple packets in a sum to perform spectral averaging thereof.

17. A system for determining an angle of arrival in a wireless network, said system comprising:
a transmitter for transmitting a plurality of packets;
an antenna array comprising a plurality of antennas;
an antenna switch coupled to the plurality of antennas;
a receiver coupled to the antenna switch, wherein the antenna switch couples the receiver to each of the plurality of antennas, one at a time;
a digital device coupled to the receiver and the antenna switch;
the receiver receives the plurality of packets with the plurality of antennas, wherein each one of the plurality of antennas receives symbols of each packet transmitted from the transmitter;
the receiver measures and compensates for carrier frequency offset (CFO) on a selected portion of each of the received plurality of packets;
the receiver determines a phase difference between each received symbol and a reconstructed phase of a signal from the transmitter; and
the digital device determines an angle of arrival (AoA) of the signal using directional characteristics of the antenna array.

18. The system according to claim 17, wherein the digital device is a microcontroller.

19. The system according to claim 17, wherein the antenna array comprises a plurality of patch antennas.

20. The system according to claim 17, wherein the antenna array comprises four patch antennas.

21. The system according to claim 19, wherein the plurality of patch antennas are fabricated on an insulated substrate and an air gap core.

22. The system according to claim 19, wherein the plurality of patch antennas are circularly polarized.

23. The system according to claim 19, wherein each of the plurality of patch antennas are spaced apart greater than one-half wavelength.

24. The system according to claim 17, further comprising isolation switches between the plurality of antennas and the antenna switch.

25. The system according to claim 17, wherein the receiver is a quasi-coherent receiver that calculates a complex correlation for each received packet.

26. The system according to claim 17, wherein the directional characteristics of the antenna array are adjusted by switching each of the plurality of antennas.

27. The system according to claim 17, wherein the directional characteristics of the antenna array are adjusted by switching each of the plurality of antennas.
